(19) United States
(12) Patent Application Publication
(10) Pub. No.: US 2017/0209779 A1
(43) Pub. Date: Jul. 27, 2017

(54) APPARATUS AND METHOD FOR MEASURING, RANKING, AND INCREASING KNOWLEDGE

(71) Applicants: Andreas L Etelközi, Tampa, FL (US); Diane C Etelközi, Tampa, FL (US)

(72) Inventors: Andreas L Etelközi, Tampa, FL (US); Diane C Etelközi, Tampa, FL (US)

(21) Appl. No.: 15/483,722

(22) Filed: Apr. 10, 2017

Related U.S. Application Data
(63) Continuation-in-part of application No. 13/632,026, filed on Sep. 30, 2012, now abandoned.

(51) Int. Cl. A63F 3/00; A63F 9/00; G09B 5/00

(52) U.S. Cl. CPC A63F 3/00643; G09B 5/00; A63F 9/0098

(57) ABSTRACT

The invention includes an apparatus and method for providing an entertaining environment that balances the “work” and “fun” attributes of an activity so as to promote knowledge accumulation and learning in anyone of a plurality of fields of interest while providing a method of centralized knowledge measurement and sharing of generic game configurations as well as custom player designed gaming configurations that can be age, gender, and skill level specific. Such apparatus and method includes game boards, handheld electronic devices, computer software and wide-area-network centralized access for information exchange between players. Additionally, certain embodiments use a dynamic database.

### CLAIM TO PRIORITY

This application is a continuation in part to application Ser. No. 13/632,026, filed on 30 Sep. 2012, of which the entire contents of such reference are hereby incorporated by this reference for all that it discloses for all purposes.

### TECHNICAL FIELD OF THE INVENTION

The present invention relates to an apparatus and method for measuring, ranking, and increasing a person's knowledge in a particular field and further using such knowledge in a competitive manner to reliably compare the knowledge level for different competitors in the same or different fields.

### BACKGROUND

Learning and obtaining knowledge is often an arduous task achieved through long, hard hours of studying a topic of interest. Further, the more complicated the knowledge desired the harder and longer one must generally work. Thus, one's effort to learn must frequently be maintained over long periods of time; particularly for more complicated subjects.

Unfortunately, Humans naturally experience “burnout” and diminished interest in an activity over time, especially when such activity is perceived as “work”. In contrast, it normally takes much longer for a Human to experience burnout for activities perceived to be “fun”. Thus, one method of minimizing burnout (or extending the pre-burnout period) is to make a work activity seem more like a fun activity.

When it comes to activities related to obtaining knowledge (educational activities), learning is often perceived as work; however, by using games, one can make a learning activity seem more like a fun activity. Thus, one goal of using games as an educational/knowledge learning tool is to extend the pre-burnout period thereby leading to more learning over time.

Games by definition are typically perceived as a fun activity. Thus, incorporating learning into a properly designed game can be used to fulfill a number of educational purposes. For example, prior art educational games have been developed that are designed to teach people about certain subjects such as flying (flight simulators). Such games include board games, card games, and video games and they may be based on pure strategies, pure chance (e.g. rolling dice), or a combination of the two.

Board games, for example, have been played in most cultures and societies throughout history; some even pre-date literacy skill development in the earliest civilizations. The first known board games represented a battle between two armies and most modern board games are still based on defeating opposing players in terms of counters, winning position or accrual of points (often expressed as in-game currency). Many types of prior art board games have been developed over time and include games that are mostly strategy with few or no collateral benefits (such as checkers, tick-tack-toe) while other games are mostly luck (such as with craps). Some games mix strategy with luck (e.g. rolling dice, timing, drawing something from a pool of things such as tiles from a group of tiles, etc.). Such games may have collateral knowledge building benefits (as with Scrabble®). Scrabble®, for example, is a word game in which two to four players score points by forming words from individual lettered tiles (picked from a group of tiles) on a game board marked with a 15-by-15 grid. In Scrabble® one develops strategic skills, spelling skills, and vocabulary while playing a game.

Notably, there has been a fair amount of scientific research on the psychology of board games such as chess. Much research has been carried out on chess, in part because many tournament players are publicly ranked in national and international lists, which makes it possible to compare their levels of expertise. Notably, such research suggests that knowledge, more than the ability to anticipate moves, plays an essential role in chess-playing. Thus, one goal of an educational game should be the accumulation of knowledge by a player.

Yet another goal of a fun learning activity should be the compiling of player data used to rank players where such rankings are presented in a centralized list. Such a ranking system will likely have the added benefit of encouraging a player to work harder to improve his/her rank especially for players with a competitive nature.

Notably, the amount of time required to learn to play or master a game varies greatly from game to game. Yet, the amount of knowledge accumulation/learning achieved by playing a game does not necessarily correlate with the number or complexity of the game's rules; some games, such as chess, for example, have simple rule-sets while possessing profound strategies. Thus, yet another goal of an educational game should be to have simple rules while promoting significant knowledge accumulation and the development of strategies for solving problems.

The progress of understanding a new concept through gaming makes an individual feel a sense of reward whether the game is considered entertainment (war simulation games) or serious (FAA—approved flight simulator). A game that motivates players to learn creates an ideal learning environment. Thus, a well-designed game will have rules and structure and goals that inspire creativity and motivate a player to play better (i.e. learn) while providing outcomes and feedback. Stated differently, while the “fun” portion of a game should not be significantly more dominate than the “learning” portion of the game, (i.e. there needs to be a reasonable balance of work and play), a player should be focused more on the “fun” (game) and not the “work” (learning) thereby making such learning fun.

Additionally, before deciding how to configure/use an educational game, the educator must first determine what they would like the trainee/student to learn. For prior art educational games, such issues are typically not addressed at all (or minimally addressed) and a game's subject is usually fixed and not easily reconfigured, if at all, to different subjects. Additionally, similar to speakers and writers, an “educator” that fails to understand his/her audience runs the risk of not connecting with such audience. In the world of educational games, an “educator” should tailor, where possible, the material to the demographic of the anticipated “gamers” (age group, gender, player familiarity with the material, educational pre-text) so that the material is neither too difficult nor too familiar to the learner.

The present invention includes an apparatus and method for addressing the above described issues by providing an entertaining environment that balances the “work” and “fun” attributes of an activity so as to promote knowledge accumulation and learning in anyone of a plurality of fields of interest while providing a method of centralized knowledge measurement and sharing of generic game configurations as well as custom player designed gaming configurations that can be age, gender, and skill level specific. Such apparatus and method includes game boards, handheld electronic devices, computer software and local and wide area networks for centralized access to information between players.

### SUMMARY

Objects and advantages of the invention will be set forth in the following description, or may be obvious from the description, or may be learned through practice of the invention.

Broadly speaking, a principal object of the present invention is to provide an apparatus and method for providing an entertaining environment that promotes knowledge accumulation and learning through an entertainment (“fun”) activity.

Yet another object of the invention is to provide an apparatus and method for providing an entertaining environment that promotes knowledge accumulation and learning through an entertainment (“fun”) activity where the apparatus and method balance the “work” and “fun” attributes of an entertainment activity so as to promote knowledge accumulation and learning in anyone of a plurality of fields of interest as represented by a selectable topic specific word set (dictionary).

A still further general object of the present invention is to provide an apparatus and method for providing an entertaining environment that promotes knowledge accumulation and learning through an entertainment (“fun”) activity while further providing a method of centralized knowledge measurement, ranking, and sharing of information including generic game configurations as well as custom player designed gaming configurations that can be demographic specific (e.g. age, gender, and skill level specific).

Another general object of the present invention is to provide a newly defined knowledge game incorporated into a method of playing a word game which is supported by a specific game board design, a well-defined set of rules, a plurality of enhanced tile mixes based on character frequency, a set of scoring principles, and collections of selectable word sets (called dictionaries).

Another general object of the present invention is to define a computer and Internet based solution for increasing a player's knowledge in a selected topic, which first allows the user to define a combination of unique and very precisely described set of criteria thereby enabling the real time electronic based search of vast amounts of data/information to collect a limited result set based on such user/player criteria. The result will be applied, stored, and reapplied in the process.

A further object of the present invention is to provide a method that eliminates or minimizes language barriers making vastly different knowledge levels and different languages measurably comparable.

Additional objects and advantages of the present invention are set forth in, or will be apparent to those skilled in the art from, the detailed description herein. Also, it should be further appreciated that modifications and variations to the specifically illustrated, referenced, and discussed steps, or features hereof may be practiced in various uses and embodiments of this invention without departing from the spirit and scope thereof, by virtue of the present reference thereto. Such variations may include, but are not limited to, substitution of equivalent steps, referenced or discussed, and the functional, operational, or positional reversal of various features, steps, parts, or the like. Still further, it is to be understood that different embodiments, as well as different presently preferred embodiments, of this invention may include various combinations or configurations of presently disclosed features or elements, or their equivalents (including combinations of features or parts or configurations thereof not expressly shown in the figures or stated in the detailed description).

Those of ordinary skill in the art will better appreciate the features and aspects of such embodiments, and others, upon review of the remainder of the specification.

### BRIEF DESCRIPTION OF THE DRAWINGS

A full and enabling description of the present subject matter, including the best mode thereof, directed to one of ordinary skill in the art, is set forth in the specification, which makes reference to the appended figures, in which:

FIG. 1 is a top plan view of a rectangular game board according to one exemplary embodiment of the invention;

FIG. 1a is a top plan view of the game board of FIG. 1 showing a Player 1 starting move (“HOUSES”);

FIG. 1b is a top plan view of the game board of FIG. 1a showing a Player 2 starting move (“CONTRACT”);

FIG. 1c is a top plan view of the game board of FIG. 1b showing a Player 1 second move (“ASARDO”);

FIG. 1d is a top plan view of the game board of FIG. 1c showing a Player 2 second move (“KOLCHAN”);

FIG. 1e is a top plan view of the game board of FIG. 1c showing shaded special squares and depicting sample player moves;

FIG. 2 depicts one exemplary embodiment of a game board scorecard;

FIG. 2a depicts an exemplary Player 1 and Player 2 scorecard showing the scoring for the moves depicted in FIG. 1a through FIG. 1e as described above;

FIG. 3 is a block diagram of one exemplary embodiment of a computer based system with centralized features;

FIG. 4 is a table presenting exemplary calculations for determining the number of individual tiles in a game-tile-set;

FIG. 5 is an exemplary Electronic Access routine block diagram for electronic based systems;

FIG. 6a is an exemplary Execute New Game routine block diagram for electronic based systems;

FIG. 6b is the continuation of the exemplary Execute New Game routine block diagram for electronic based systems;

FIG. 7 is an exemplary Dictionary, Board, and Tiles routine block diagram for electronic based systems;

FIG. 8a is an exemplary New Dictionary routine block diagram for electronic based systems;

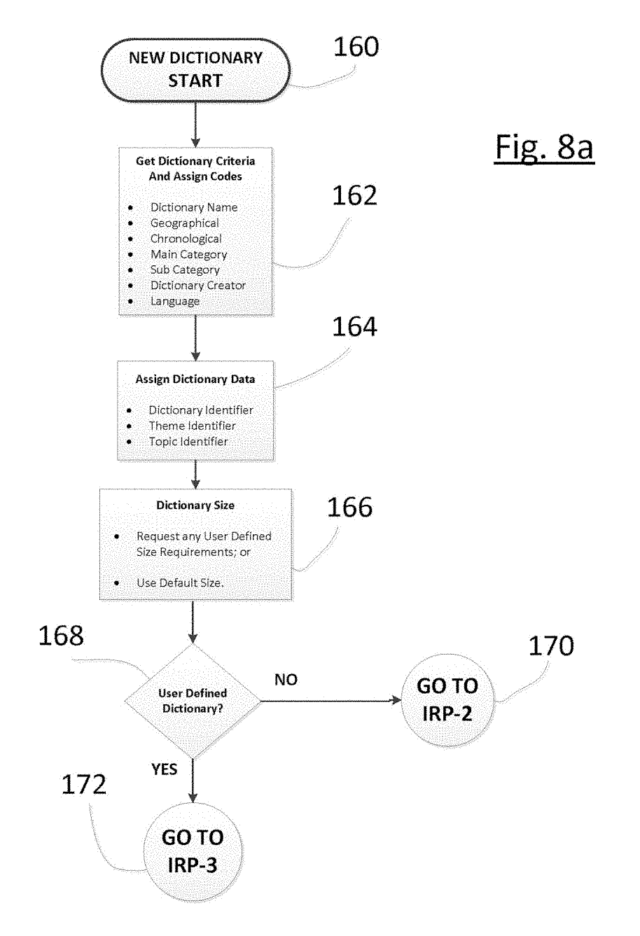

FIG. 8b is the continuation of the exemplary New Dictionary routine block diagram for electronic based systems;

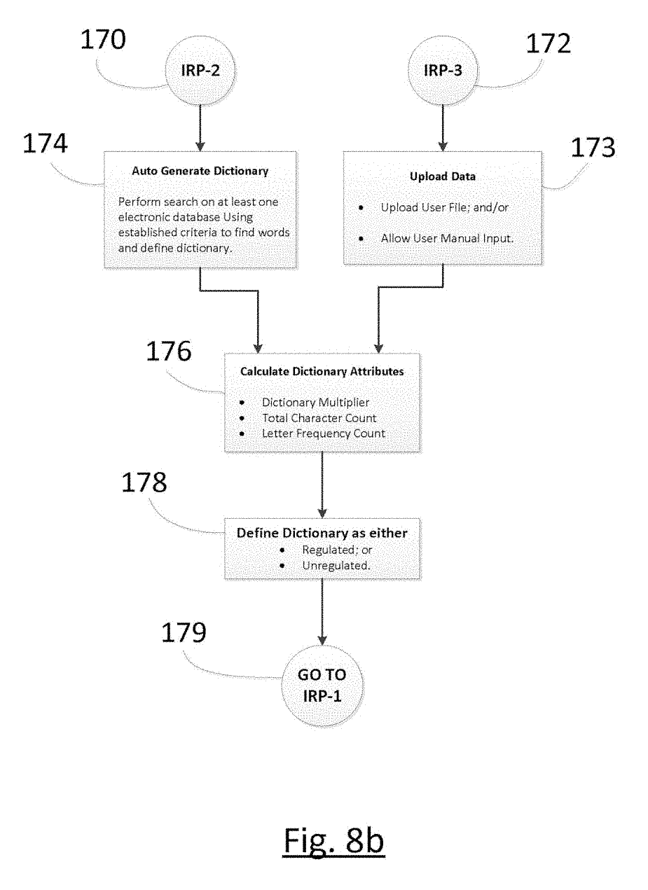

FIG. 9 is an exemplary Board and Tiles routine block diagram for electronic based systems;

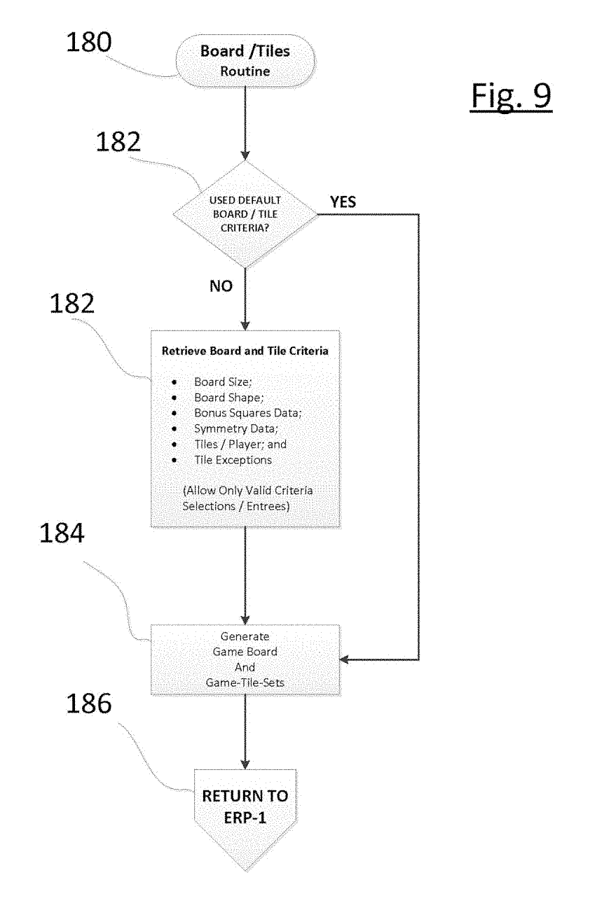

FIG. 10a is an exemplary Documenting and Scoring routine block diagram for electronic based systems; and

FIG. 10b is the continuation of the exemplary Documenting and Scoring routine block diagram for electronic based systems.

Repeat use of reference characters throughout the present specification and appended drawings is intended to represent the same or analogous features or elements of the present technology.

### DETAILED DESCRIPTION

Reference now will be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention covers such modifications and variations as come within the scope of the appended claims and their equivalents. Other objects, features, and aspects of the present invention are disclosed in or may be determined from the following detailed description. Repeat use of reference characters is intended to represent same or analogous features, elements or steps. It is to be understood by one of ordinary skill in the art that the present discussion is a description of exemplary embodiments only, and is not intended as limiting the broader aspects of the present invention.

It should be appreciated that this document contains headings. Such headings are simply place markers used for ease of reference to assist a reader and do not form part of this document or affect its construction.

### Construction Aids

For the purposes of this document two or more items are “mechanically associated” by bringing them together or into relationship with each other in any number of ways including a direct or indirect physical “releasable connections” (snaps, screws, Velcro®, bolts, etc.—generally connections designed to be easily and frequently released and reconnected), “hard-connections” (welds, rivets, macular bonds, generally connections that one does not anticipate disconnecting very often if at all and that generally needs to be “broken” to separate), and/or “moveable connections” (rotating, pivoting, oscillating, etc.).

Similarly, two or more electrical items are “electrically associated” (sometimes simply “associated”) by bringing them together or into relationship with each other in any number of ways including: (a) a direct, indirect or inductive communication connection, and (b) a direct/indirect or inductive power connection. Additionally, while a drawing may illustrate various electronic components of a system connected by a single line, it will be appreciated that such “signal line” may represent one or more signal paths, power connections/paths, electrical connections and/or cables as required by the embodiment of interest.

For the purposes of this document, unless otherwise stated, the phrase “at least one of A, B, and C” means there is at least one of A, or at least one of B, or at least one of C or any combination thereof (not one of A, and one of B, and one of C).

A “game” herein is the act of arranging tiles from a set of tiles during a competition according to a set of rules. A “gaming system” includes a set of tiles and a rule book and may further include a board for receiving tile arrangements, where such tiles and board may be generated by electronic/digital devices that implement software routines.

A “board based game” is a game that uses a physical board where the players typically sit around a table (for example) and play the game.

A “board” may be a digital construct of a physical board generated by a computing device and displayed on a display device. Similarly, “tiles” may be a physical item designed to be placed on a game board or a digital construct of a physical tile generated by a computing device and displayed on a display.

An “Electronic based game” is a game that is played using electronic devices (computing devices) such as application specific computers, handheld computers, notebook computers, tablet computers, etc., and computer networks where such computing devices are configured to generate the digital constructs of the game components and display/present such constructs to a user on a output device such as a visual display device or sound based interface device.

A “computing system” includes, for example, all the typical hardware and software required to implement an electronic based game including computers, personal digital assistants, cell/mobile phones, other electronic devices having at least a processor, memory and a display device for displaying the digital constructs of the gaming components.

For the purposes of this document, “automatically” means tasks performed by use of automation (although such tasks may or may not be performed immediately). Examples include general purpose computing hardware configured by software thereby forming specific purpose computers. More particularly, steps performed “automatically” are performed by a machine.

Throughout this document, unless expressly stated otherwise, any reference to a step in a process presumes that the step may be performed directly by a party of interest and/or performed indirectly by the party through intervening mechanisms and/or intervening entities, and still lie within the scope of the step. That is, direct performance of the step by the party of interest is not required unless direct performance is an expressly stated requirement. For example, a step involving action by a party of interest such as “placing”, “sending”, “displaying”, or “viewing” and a destination may involve intervening action such as moving, forwarding, instructing, copying, uploading, downloading, encoding, decoding, compressing, decompressing, encrypting, decrypting and so on by some other party, yet still be understood as being performed directly by the party of interest. Further, the order in which a step is performed is not mandatory unless specifically noted otherwise.

This document includes headers that are used for place markers only. Such headers are not meant to affect the construction of this document, do not in any way relate to the meaning of this document nor should such headers be used for such purposes.

While the particulars of the present invention may be adapted for use in any gaming environment, the embodiments described below are for use with board based games and in particular a board game called CREXICA® although note that the game CREXICA® may also be an electronic based game.

### Written Description

As noted above, the present invention includes an apparatus and method for providing an entertaining environment that promotes knowledge accumulation and learning through an entertainment (“fun”) activity.

The first embodiment relates to a newly defined knowledge game incorporated into a method of playing a word game which is supported by a specific game board design, a well-defined set of rules, a plurality of enhanced tile mixes based on character frequency, a set of scoring principles, and collections of selectable word sets (called dictionaries) that may be dynamically generated in real time. Certain embodiments balance the “work” and “fun” attributes of an entertainment activity so as to promote knowledge accumulation and learning in anyone of a plurality of fields of interest as represented by a selectable topic specific dictionary. The rule set is simple to learn while providing profound strategy and knowledge accumulation features. Additional features provide a method of centralized knowledge measurement, ranking, and sharing of information including generic game configurations as well as custom player designed gaming configurations that can be demographic specific (e.g. age, gender, and skill level specific).

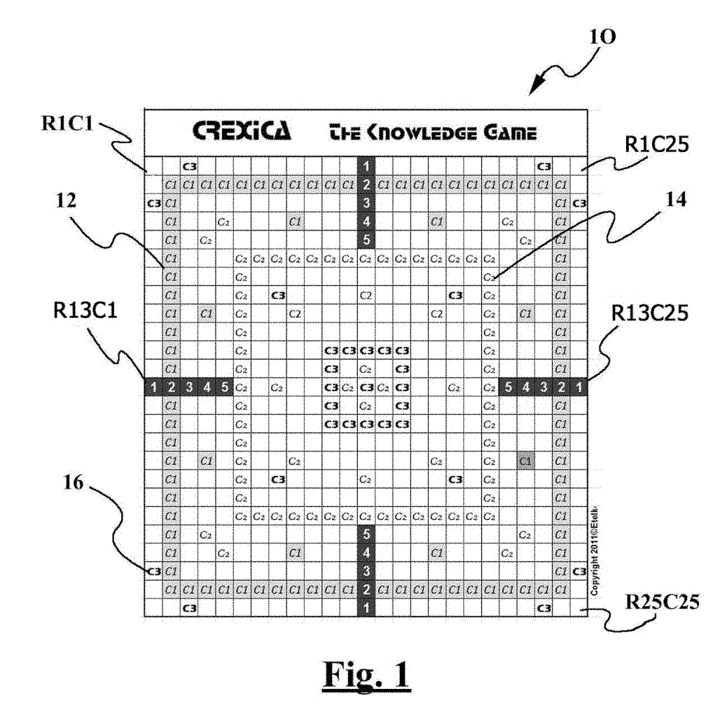

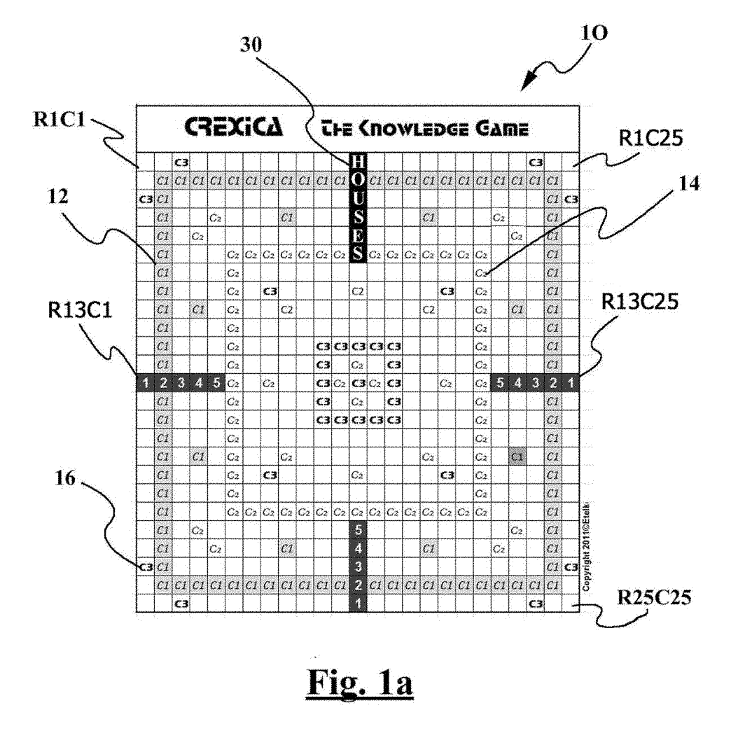

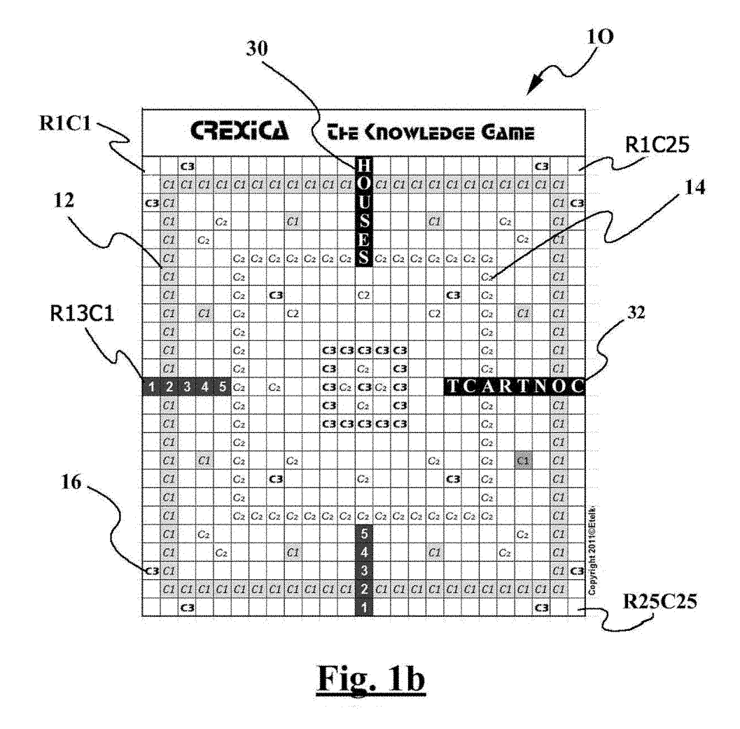

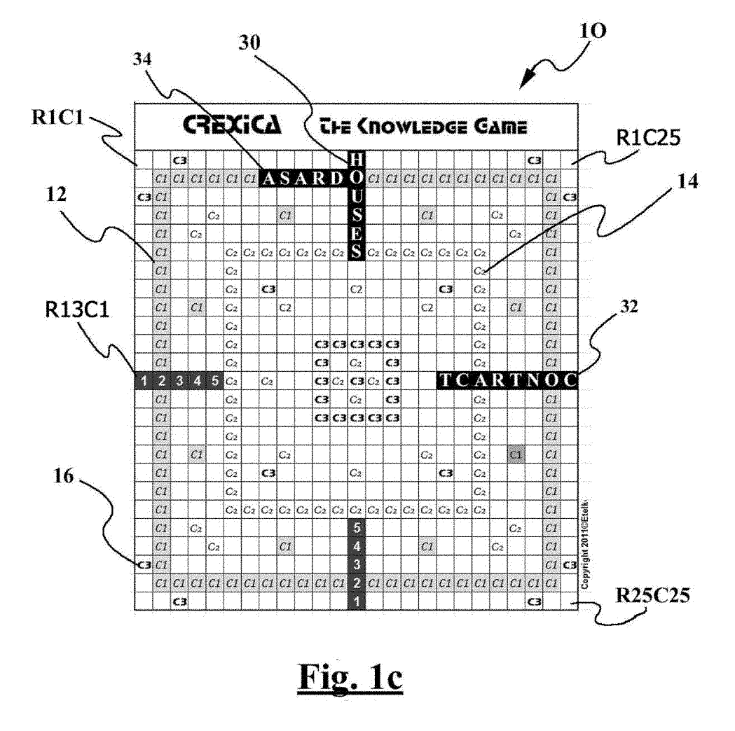

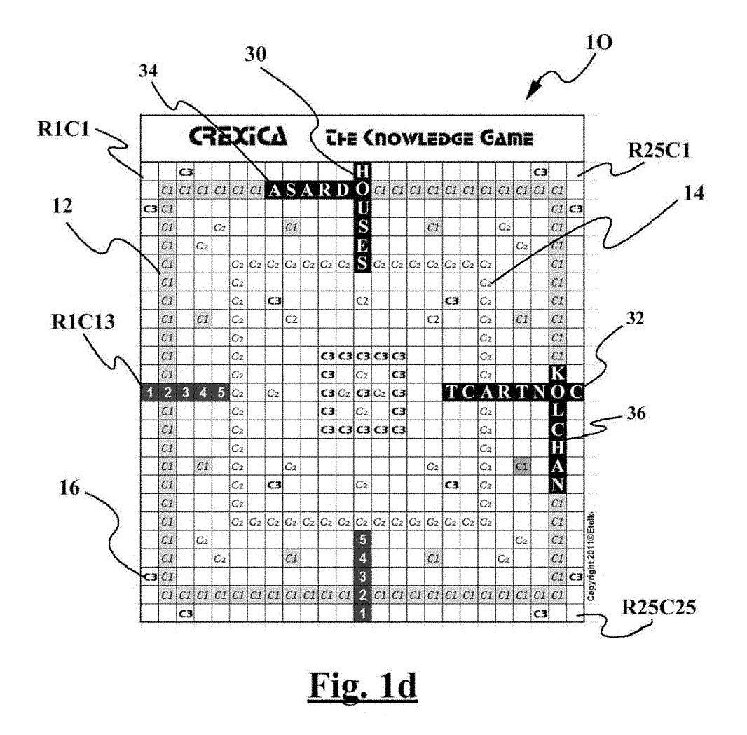

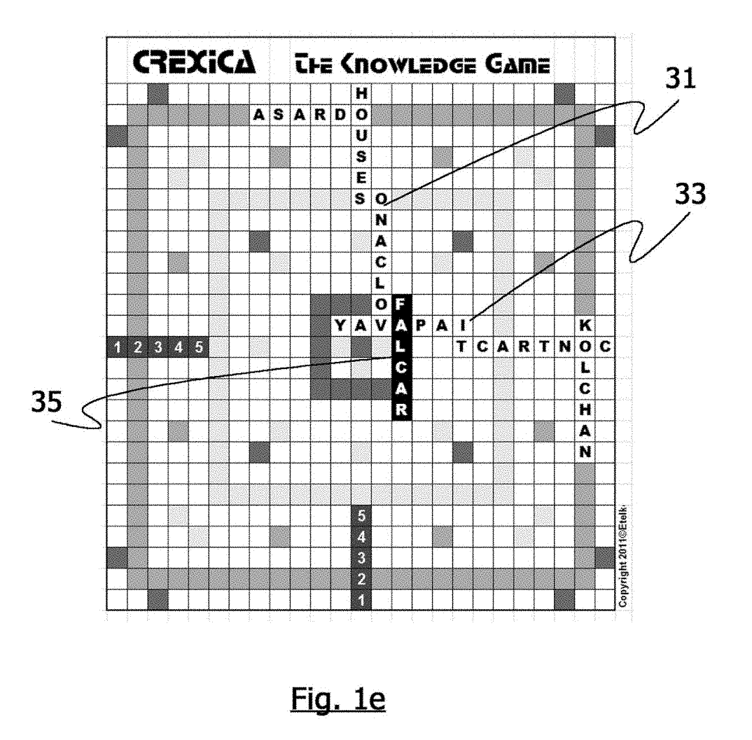

Referring now to FIG. 1, a top view of a rectangular game board (10) according to one exemplary embodiment of the invention is presented. It will be appreciated that game board (10) may define any polynomial shape. For the purposes of this document, circles are polynomials. For the current embodiment, Game Board (10) comprises a surface defining a 25×25 square matrix of equally sized square boxes (or cells) for a total of 625 squares. As depicted in FIG. 1, the first square is identified as R1C1 and the last square is identified as R25C25 (where “R” stands for row, and “C” stands for column). The board's matrix defines four starting point square sets comprising five squares numbered 1 through 5 where the first square is positioned at the halfway point along an outer boundary of the matrix. For example, as depicted in FIG. 1, square R13C25 is square 1 of one such starting point square set and square R13C21 is the fifth square. Similarly, square R13C1 represents the beginning of another starting point square set.

For the current embodiment, game board (10) includes squares that are (a) starting point squares, (b) squares that represent blank color (no bonus points), and (c) bonus point squares that represent one of three colors (C1, C2, C3). It will be appreciated by one of ordinary skill in the art, that any number of starting point squares, color squares, blank squares, or number of different colors may be used without departing from the scope and spirit of the invention. Further, any suitable method may be used to identify bonus squares. As depicted in FIG. 1, there are 20 starting point squares (5×4), 92 C1-squares (23+23+21+21+8−4), 76 C2-squares (15+15+13+13+4+8+8), 30 C3-squares (1+17+4+8), and 407-blank color squares.

### Dictionaries

As will be described in detail later, the players will place tiles on game board (10) side-by-side to form words found in dictionaries. For the preferred embodiment, there are three types of dictionaries: (1) Language Specific general dictionaries; (2) Topic specific dictionaries; and (3) Collective dictionaries. Language specific dictionaries should contain all, or a large subset of all, the words found in a typical dictionary for a particular language (but typically no proper names, no acronyms, no abbreviations). For the preferred embodiment, Topic specific dictionaries will only contain proper names, abbreviations and acronyms related to a particular topic. Collective dictionaries should contain all the words in a set of topic specific dictionaries.

For example, one topic specific may be called “Indian Tribes” and contain the names of all the known American Indian tribes. Yet another topic specific dictionary may be called “American Car Makers” and contain the names of all past and present “American Car Makers”. A collective dictionary would contain all the words in both the Indian Tribes and American Car Makers dictionaries.

Such dictionaries may define any one of a plurality of themes each consisting of a plurality of topic specific dictionaries. Exemplary themes include: (1) Sports, (2) The World, (3) Americana, (4) History, (5) Art, (6) 21^{st} Century Geeks, (7) Science, and (8) The Financial World. Of course, such themes can include sub-themes. For example, “Music” can be a sub-theme of “Art”. Similarly, “Chemistry” and “Algebra” can be sub-themes of “Science”. Each theme would consist of a plurality of topic specific dictionaries. For example, the theme of “Science” may contain topic specific dictionaries including Natural Sciences, Social Sciences, Human philosophy, psychology, engineering, medicine, physics, electronics. Further, “Natural Sciences” may be a sub-theme of “Science” where “Natural Sciences” comprises a plurality of topic specific dictionaries related to “Natural Sciences”.

Preferably, each topic specific dictionary and language specific dictionary will identify the creator of the dictionary, a total-characters-count representing the total number of characters in the dictionary, a character-count (frequency) for each individual character found in the dictionary, the tile count for each individual character, and a scaling factor for scoring.

Similarly, collective dictionaries are formed by combining one or more topic specific dictionaries and/or at least one language specific dictionary. For example, if there are 6 topic specific dictionaries for a particular theme, a collective theme dictionary would include 2 or more of the 6 topic specific dictionaries. Further, a collective dictionary may contain all the dictionaries in a game set.

For one embodiment comprising discrete dictionaries, a game board, and tiles, the game will have a general theme such as “Americana” and such teem will have 6 topic specific dictionaries (preferably regulated as described below). The game will also provide on Collective dictionary that includes all 6 topic specific dictionaries. Further, for one embodiment, only one game-tile-set is provided that is used for all dictionaries. Alternatively, a plurality of game-tile-sets may be provided providing for different character frequencies.

Dictionaries that comply with a set of rules and associated criteria for ranked playing are defined a “regulated dictionaries”. All other Dictionaries are considered “un-regulated dictionaries” until approved as a regulated dictionary. By way of example, one possible criterion for a regulated topic specific dictionary would be the requirement to contain a minimum amount of words. In contrast, for one embodiment, user defined unregulated dictionaries can have any number of words desired by the user.

For electronic versions of the game, for one embodiment, users can define their own topic specific dictionaries which may be specifically designed for a particular group of people. By way of example, suppose teacher Smith creates a user group on centralized server (106) with the name “Smith's 8th Grade Science Class” where teacher Smith further establishes a theme called “8^{th} Science” and within such theme teacher Smith creates topic specific dictionaries (1) cellular biology, (2) genealogy, (3) mammals, (4) invertebrates, etc. Each student in teacher Smith's class is given access to the “Smith's 8th Grade Science Class” user group and can logon to centralized server (106) and play games with fellow students using teacher Smith's topic specific dictionaries (likely related to material to be learned over a particular period of time). All such user generated dictionaries are considered un-regulated dictionaries until evaluated and approved for use as a regulated dictionary.

Each dictionary should list its multiplier value, preferably on the first page of the dictionary for dictionaries in hardcopy (as opposed to electronic dictionaries). For the currently preferred embodiment, multiplier values are calculated according to the table below.

MULTIPLIER VALUES

| Dictionary | Multiplier |
|---|---|
| 1000 words | 5 |
| 2000 words | 4 |
| 5000 words | 3 |
| More than 5000 | 2 |
| words | |

In addition to the dictionary multiplier identified above, preferably, the topic specific dictionaries also identify the theme “T”, theme/category “TC”, theme/subcategory “TSC”, total character count for dictionary “TCC”, character frequency count representing the total number of times a particular character occurs in the dictionary, Dictionary Creator “DC” ID (e.g. User, Manufacturer, etc.), dictionary registration status “S”: Regulated/unregulated, the date of creation “DOC”, and the date of registration “DOR”.

Accordingly, one example of a Dictionary Metrics format is as follows:
M5;T010;TC020;TSC030;TCC7229;A15.2;B1.1;C4.5;D1.3;E7.6; F.24;G1.45;H4.5;I8.8;J.39;K4.3;L4.7;M3.5;N7.8;O7.1;P2.9;Q.79;R2.3;S5.5;T5.9;U5.1;V.44;W2.4;X.34;Y1.5;Z0.4;DCMF G;SR;DOC20120115;DOR20120901.
   This string of characters can be easily interpreted by a user or computer program and inform same that:
1. “M”—the dictionary Multiplier (M5) is “5”;
2. “T”—the Theme code is “010” (a lookup code);
3. “TC”—the theme/category code is “020”;
4. “TSC”—the theme/subcategory code is “030”;
5. “TCC”—the total character count is 7229;
6. “A15.2”—the tile frequency character “A” is 15.2% (i.e. “A” makes up 15.2% of the 7229 characters);
7. “DC”—the Dictionary Creator is “MFG” which refers to the game manufacturer;
8. “S”—the Dictionary Status: “R” Regulated;
9. “DOC”—the date of creation was Jan. 15, 2012; and
10. “DOR”—the date of Registration Sep. 1, 2012.
   Of course any suitable schema may be used.

### Game Tiles

The current embodiment of the invention further includes a set of character tiles similar to tiles used in prior art games. The length and width dimensions of such character tiles are less than or equal to the length and width dimensions of the squares defined by game board (10) so that one of such character tiles may be placed over and cover at least part of a game board (10) square but should not cover an adjacent square. Any reasonable number of character tiles may be used, however, for the currently preferred embodiment allowing up to four players, there will be 204 character tiles which are referred to as the game-tile-set.

For electronic versions of the game, it is possible for a program to generate a game board that includes more than four starting points allowing more than four players. For games allowing more players, the number of character tiles in the game-tile-set will be dependent on the number of players.

For the currently preferred embodiment, there are a maximum of four players and 51 character tiles per player for a total of 204 tiles in the game-tile-set. It will be appreciated, however, that for the preferred embodiment, if there are only two or three players, the game-tile-set will still be 204 tiles, not 153 (i.e. not 204-51). For one alternative embodiment, where computer programs are calculating the tile features, more than four players can simultaneously play one game and the game-tile-set optionally increased by 51 tiles (or any other suitable number) for each additional player over four players and the board size modified to include more starting points and maintain “balance” (symmetry) in the game board.

The character tiles will either be blank or at least one surface will define tile-data (i.e. have some character or icon defined on one surface). Such character tiles are configured so that one tile covers one square defined by game board (10). During a move, a player places a plurality of character tiles side-by-side with each tile being placed over one square defined by game board (10) so that the tile-data associated with the plurality of character tiles conveys information (e.g. words) to the players.

Further, as described in the example above, a particular game may include an English dictionary, an Indian Tribes topic specific dictionary, and an American Car Makers topic specific dictionary. Additionally, collective dictionaries may be composed of any combination of such dictionaries. The number of individual characters in a game-tile-set (called the “character-count” for that character) is calculated according to any desired algorithm. For the currently preferred embodiment, the frequency of occurrence of a character within a particular dictionary is used in a default algorithm to determine the number of tiles that will display such charter that is reflective of its frequency value (“reflective of” means plus/minus 5%).

Where the tiles define characters of a language (e.g. English) the frequency of letters within the game-tile-set either: (1) reflective of (i.e. +/−5%) the frequency of occurrence in the relevant language specific dictionary; (2) reflective of (i.e. +/−5%) the frequency of occurrence in the relevant topic specific dictionary; and/or (3) reflective of (i.e. +/−5%) the frequency of occurrence in a collective dictionary.

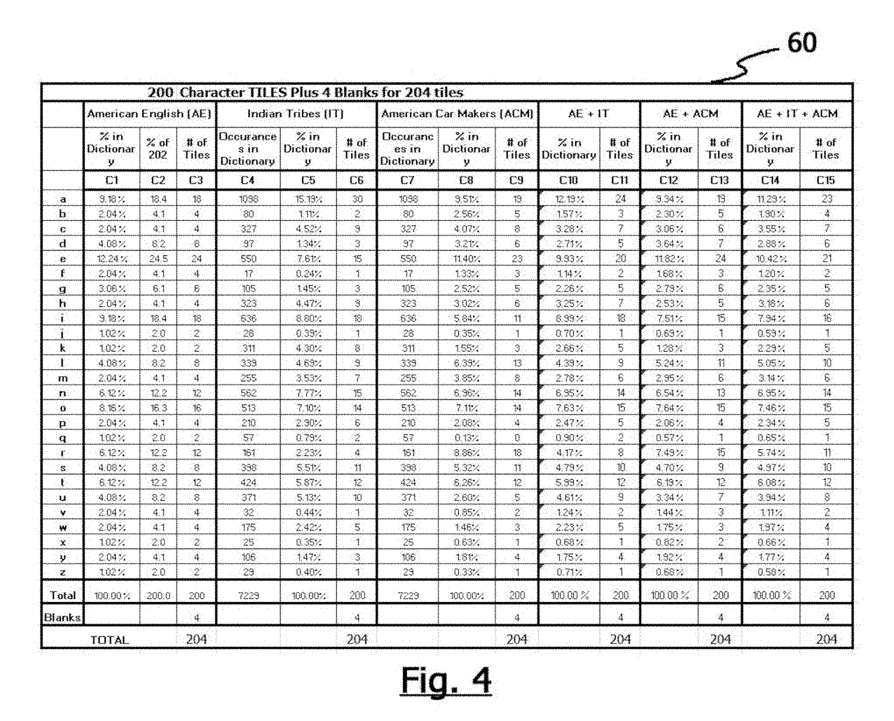

FIG. 4 presents a table (60) showing the character-count for a game set containing an English dictionary, Indian Tribes dictionary, and American Car Makers dictionary. Column C3 shows the character-count for the English dictionary, Column C6 shows the character-count for the American Tribe dictionary, and Column C9 shows the character-count for the American Car Makers dictionary. Columns C11, C13, and C15 show character counts for collective dictionaries.

For the currently preferred embodiment, the frequency of occurrence of the letters within the game-tile-set reflects the frequency of occurrence in the relevant language including any language specific characters (such as ä and ö) and associated conversion tables (such as “o” is accepted as “ö”). For example, in English, the character “A” occurs 9% of the time and the character “B” 2% of the time. Thus, about 9% of the tiles (18 tiles, rounded up) in the 200 game-tile-set will define an “A” and 2% of the tiles (4 tiles) will define a “B”. There will be 4 “blank” tiles. Again, “reflective of” and “about” means+/−5%.

As will be described below, for electronic versions, the dictionary may be almost any topic specific dictionary and such dictionary may be dynamically defined. Further, for some games, each player may use a different topic specific dictionary. For such embodiments, once the dictionaries to be used are selected, the programming routine determines the number of unique characters used in the relevant dictionaries and calculates the character frequencies for each unique character, configures the number and type of tiles that will make up the game-tile-set, and determines the weighted scoring method be used (if any).

### Central Server

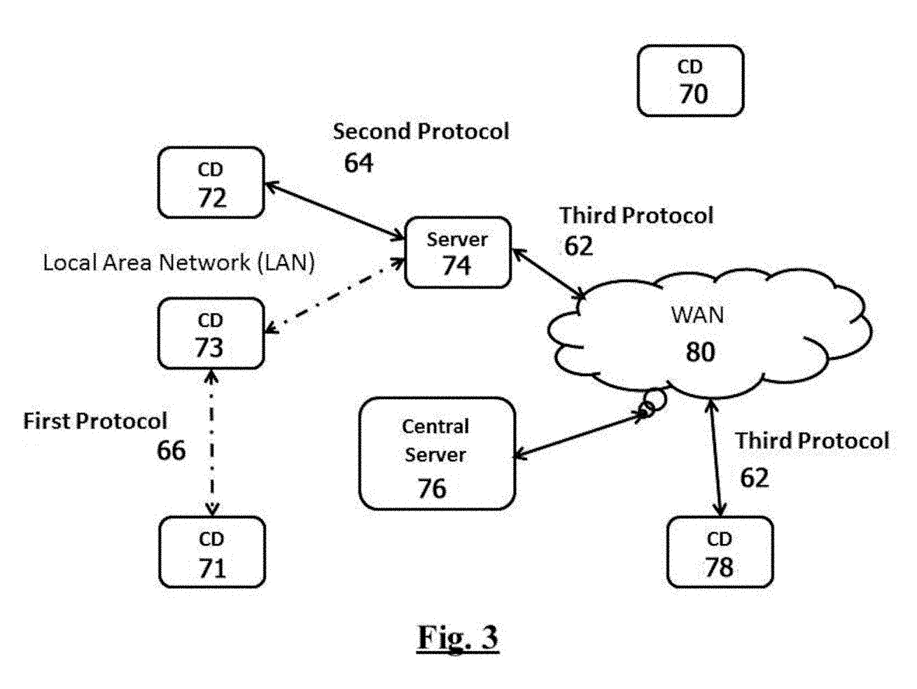

As depicted in FIG. 3, some configurations allow users to compete with each other over a computer network including Local Area Networks (LAN) and Wide Area Networks (WAN). Such system defines on embodiment of an electronic based gaming system for providing an entertaining environment for enhancing a person's knowledge in a particular area. A first computing device (76) is configured to communicate with a plurality of slave computing devices (e.g. computing devices 71-74) over at least one of a wide area network and a local area network.

The first computing device (76) is configured for generating display data and transmitting said display data a plurality of slave computing devices (71-74). Such display data comprises the information necessary for each slave computing device to generate at least part of the various display images needed to play and document the progress of the game including board data (shape and size of the game board as well as other board attributes) defining a game board defining a playing area comprising a plurality of adjacent cells with each cell having a cell perimeter defining a polynomial.

Such first computing device (76) maintains a plurality of topic specific dictionaries wherein each topic specific dictionary contains a collection of words associated with its respective topic. Said first computing device further maintains at least one of (a) a standard dictionary and (b) a collective dictionary, wherein said standard dictionary contains a collection of words in at least one language and wherein said collective dictionary contains all (or almost all) the words of said plurality of topic specific dictionaries.

Central Server (76) is further configured maintain game-tile-set data and/or generate a game-tile-set data. Game-tile-set data includes at least one of the number and type of characters, the character frequency for each character, and tile-data.

Central server (76) further maintains a list of players that are allowed access to the gaming system and, upon receiving a new game request, Central Server (76) either automatically selects the qualified players needed to start a new game or allows qualified players to manually request access to said new game as well as allow each player to select a topic specific dictionary from said plurality of topic specific dictionaries which becomes the player's dictionary.

While it is possible that such games could be played using discrete boards at each player site, with the individual moves being relayed via the computer network so that a player may manually make the necessary moves, preferably the various game components are images displayed on a display device where such images are generated by software executed by Computing Devices (CD) such as laptops, desktops, or handheld computers (such as smartphones). Where all the players are at one location, such software may be run on a stand-alone computing device such as CD (100) which may comprise a plurality of computing devises (in communication with each other) specifically designed for the relevant games. Preferably, the CD devices are configured with the hardware (such as GPS) or software to acquire the location for the CD device and generate location data. Alternatively, the server computer may use data such as an IP address to acquire location data for the CD device.

For one preferred embodiment, at least part of the gaming software is loaded on a plurality of computers at various locations (typically remote relative to one another). As depicted in FIG. 3, such software may be run on a first CD (71) wired or wirelessly connected to a second CD (73) over a Local Area Network (LAN) using a first protocol (66), which may be further wired or wirelessly connected to a central server (76) through a Wide Area Network (WAN) (80) using a third Protocol (62) or through an intermediate server (74) using a second Protocol (64). For the current configuration, some or all of the game software (as needed) may be loaded on CDs (70), (71), (72), (73), (74), (76), and (78) allowing at least one player at each site. One of ordinary skill in the art will appreciate that such a configuration allows players to play each other from just about any location supplying a communication connection back to a master-controller such as Central Server (76).

As depicted in FIG. 3, central server (76) is configured to run the main gaming software routines. Player interface routines are run on the individual CDs (71), (72), (73), and (78). All or part of the gaming software may be downloaded from central server (76) to remote computing devices such as CD (78) and be represented by a smartphone application. Central server (76) further provides a common location for downloading software updates, downloading unregulated and regulated topic specific dictionaries, uploading unregulated player generated topic specific dictionaries, downloading a player interface for arranging and controlling games between various players, and for calculating and maintaining a list of player rankings. For one embodiment, the desired language for a player using a remote CD is not known, the server automatically retrieves location information (e.g. IP address, GPS data) from a particular CD, access a remote data base to determines the official language (or majority language if no official language) for that location data and configures its display data for that CD in the official language for the location data. For example, in France, the official language is French. Similarly, the server may further automatically generate a dictionary (such as a topic specific dictionary) base, at least in part, of such location data. Thus, if the location data indicates the CD is in France, the display data may be automatically generated in French and a list of topic specific dictionaries may be generated, based at least in part, on such location data and presented to a user for possible selection. Continuing with the above example, a dictionary of French wines, French vineyards, and landmarks may be generated.

Further, central computer (76) may provide for the establishment of user groups for selected members. Examples of user groups include members of the science club, members of a society, members of a school, and students in the classroom. Additional functions of central computer (76) will be explored below.

### Game Components

For the currently preferred non-computer based embodiment, the game components include a game board (10), an optional timing device (not shown in drawings), four tile holders (not shown in drawings), a rule booklet (not shown in drawings), at least one set of 204 tiles (the letter frequency of which is calculated by the game issuer based on the language of the edition and the dictionaries of the subcategories), scoring cards (40), and a plurality of dictionaries representative of one or more themes, languages, collective combinations and scoring “cheat sheets” listing the recommended scoring guidelines and points. There will be a plurality of game themes offered and the container holding the game components will be specific to the particular theme. The game set should also include a small non-transparent bag to store letter tiles and to hold the tiles in a randomized manner allowing players to draw tiles out of such bag without being able to see the tiles (during play).

The plurality of themes include: Americana, The World, Around the World, History, Sports, Art Experts, 21^{st} Century Geeks, and Wall Street Wizards. There will be at least one topic specific dictionary for each theme. For Americana, the topic specific dictionaries include: US Cities, Colleges & Universities, US Car Makers, US Rivers, US Indian Tribes, Sports Hall of Famers. The other themes would have similar topic specific dictionaries defined. A Collective dictionary contains all the words in the category dictionaries of a specific theme, for example “Americana”, and the multiplier of the collective dictionary is any predefined number such as ‘2’. All the common words in a particular language and all the words registered in the selected dictionary (topic specific or collective) are considered valid.

For one alternative embodiment, the dictionaries may be electronically stored in at least one electronic device that may be either application specific or a general purpose device (e.g. PDA, smartphone, laptop, etc.). Such dictionaries may be updated and the number of dictionaries dynamically increased through any suitable communication connection/interface.

For yet another alternative embodiment, as noted above, the game components may be computer generated images created by software routines run on local computers or remote network computers.

### How to Play the Game

The object of the game is to win by accumulating more points than the other players by applying knowledge of the words in a particular dictionary of words relevant to well-organized subjects (geography, history, sports, science, etc.).

### a) Select Game Version

Before the game begins, the players agree on the game version to be played. The game versions include: (1) Basic Version; (2) Single Dictionary Game using a Collective Dictionary; (3) Single Category Games; and (4) Multi-Category games.

For the Basic Version, the players agree to use words found in a common language dictionary (such as English) excluding proper names, acronyms, and abbreviations.

For Single Dictionary Game using a Collective Dictionary, the players agree that all the common words in a particular language and all the words registered in a collective dictionary for the game edition will be considered valid. The collective dictionary is used to verify the words put on the board by the players.

For Single Category Games, the players select one topic specific dictionary. All the common words in a particular language and all the words registered in the selected topic specific dictionary are considered valid. The selected topic specific dictionary is used to verify the words put on the board by the players.

For Multi-Category Games, each player selects one topic specific dictionary from a plurality of topic specific dictionaries. Two or more different players may select the same topic specific dictionary. For this version, all the common words in a particular language are valid for all players. Additionally, for each player, all the words registered in their selected topic specific dictionary are valid. One of ordinary skill in the art will note that this version allows the players to build their knowledge in their selected topic. Additionally, for this version of the game, players may use the dictionaries to look up words to play in the game (time permitting). Players confident in their selected topic specific area may choose not to use the dictionaries to look up words to play. Such players receive additional bonus points for each word played as described later.

### b) Select User Selectable Rules

The various game versions have user selectable rules. Preferably, each user selectable rule has a corresponding default value. A default value is the value that is used if not change is made. For example, assume a turn-time may be used and set to any value between 0 and 90 seconds. Assume the turn-time default value is defined as 90 seconds. If the players do not vote to change the turn-time value, it will be the default value of 90 seconds.

The user selectable rules are as follows:

(1) Turn-Time: The time allowed for completing one's turn is defined as turn-time. Setting a turn time may be done for any game version and is highly recommended for versions that allow users to use the dictionaries to lookup words to play. Each turn may be time limited or there may simply be an overall time limit for each player and a countdown timer used to track time remaining. The default value for the play time is 90 seconds per turn.

(2) Game Ending Event: The players may select at least one of three methods of defining when a game is over. First, the game may end after a set time such as 2 hours (default time: 2 hours). Second, the game may end after a particular number of rounds (default value: 20 rounds). Third, the game may end when a player reaches a predefined number of points (default value: 300 points). Forth, for games were each player is given a total play time and a countdown timer is used to track the time remaining, the game ends when a player's total time reaches zero.

(3) Ultimate End Game Rule: The game ends when a player runs out of tiles and there are no replacement tiles.

(4) Dictionaries: If applicable, players decide whether or not they are going to use their selected dictionary to look up the words to play. Access to dictionaries is granted based on such criteria.

### c) Making Moves

For embodiments having discrete game components and the players sit around a table in the same room while playing the game, the game board (10) is placed in the middle of the table with a starting-point (as described above) in front of each player. All the tiles in the relevant game-tile-set are put into a container and thoroughly randomized (mixed). To determine who starts the game, each player draws one tile. The letters on such tiles are used to determine the player who starts. For example, assuming the dictionary is English, the tiles will represent letters of the English alphabet and the player who draws the tile having the letter closest to the character “A” starts the game (i.e. “B” is closer than “C” and “C” is closer than “D”, etc.). It should be appreciated, however, that any suitable method of selecting the starting player may be used without departing from the scope and spirit of the present invention.

The order of play is clockwise from the starting player. Before the game starts, each player draws 9 more tiles for a total of 10 tiles.

The rules governing the player moves are as follows:

Rule 1. The players, on their turn, associate two or more tiles on the game board to form a word and place the tiles forming such word on adjacent squares of game board (10) at their “starting-point” (i.e. the 5 starting-point squares).
a. While the first tiles forming the first word must be placed along the five starting-point squares, after such first move (assuming the “starting requirement” has been meet), the tiles may be placed on game board (10) in any one of 4 directions (upwards, downwards, left, and right) on any square as long as at least one letter from an existing word on the board is used (described in detail below).
b. For the preferred embodiment, no diagonal placing is allowed.
c. As noted above, each player has a series of 5 starting squares that only he/she can place a tile on. All other squares define the “community board” squares where any player can place a tile.
d. Starting Requirement: Before a player can place a tile on a community board square, all starting squares must be covered by a tile. Such is referred to as the “starting requirement”.
e. If a player is unable cover all the 5 starting squares on their first play, he/she must add letters on the following turn(s) to form another word and satisfy the starting requirement on that turn.
f. A “round” has been completed when all players have made the same number of plays/turns.
g. OPTIONAL RULE: If a player is unable to cover all 5 start squares in the first 3 rounds, he/she would get relief and be allowed to continue anywhere else on game board (10) in the 4th round.

Rule 2. Once a player has satisfied the starting requirement, such player is entitled to use the community board squares and is allowed to add letters and/or words to any players' words.
a. A player makes a move by placing one or more “new tile(s)” on game board (10) where each new tile is placed over a square and where at least one new tile is adjacent to a tile already on the board (“old tile”).
b. New words are formed by either: (i) forming a new word that connects to a word already on the board (“old word”); or (ii) adding one or more tiles to an old word (word already on the board) changing such old word.
c. The new word may use reverse direction of an original word. For example, the word “LOVE” placed on game board (10) in the normal left-to-right direction can be enhanced to “REVLOVER” (which is “REVOLVER” spelled backward). Notably, embedded words, such as “LOVER” do not count.
   However, for one alternative embodiment, if all new characters create a word in both the forward and reverse direction, both words are counted (e.g. “DOG” and “GOD”).
d. A player may place tiles to the beginning or ending of an existing word that reads across (from left-to-right or right-to-left), up, or down on game board (10).
e. A Player may place a word at right angles to a word already on the board.
f. The new word must use one of the letters already on the board (“old word”) or must add at least one letter to the old word to form a new word.
g. All modified and newly created words must fulfill the criteria of the allowed words in the game.
h. A Player may place a complete word parallel to a word already on game board (10) as long as all adjacent letters also form complete words.

Rule 3. After making a move, the player's score is calculated and announced and the player then draws new tiles from the container of game-tile-set tiles to replace the ones played. Thus, a player should always have 10 tiles on his/her rack as long as there are enough tiles remaining.

Rule 4. No tile may be moved or removed after it has been played and scored.

Rule 5. A player may use his/her turn to exchange all or some of his/her tiles with new tiles (perhaps a player is unable to form words the tiles he has). To exchange tiles, the player sets aside the “old tiles” to be replaced (face down) and the same number of new tiles are drawn from the game-tile-set. The Player then returns the “old tiles” to the container holding the game-tile-set tiles. Such player receives no points.

Rule 6. Any player may “challenge” a word played by another player. Such challenge must be made prior to the next player starting their turn. The challenger or other players may look in the appropriate dictionary to verify the word used. If the word challenged is not in the relevant dictionary, the challenged player removes the tiles played from game board (10) and loses that turn. If the challenged word is in the relevant dictionary, the challenger loses his/her next turn. All words made during a move that is challenged are included in such challenge.

Rule 7. The game ends when the conditions for ending the game, as identified above, have been met.

### d) Scoring

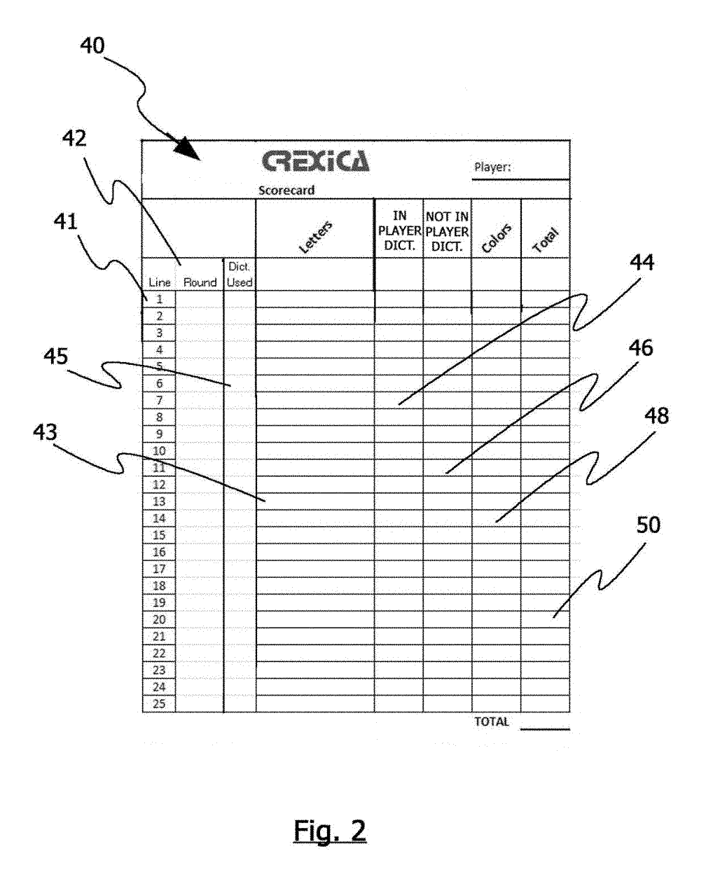

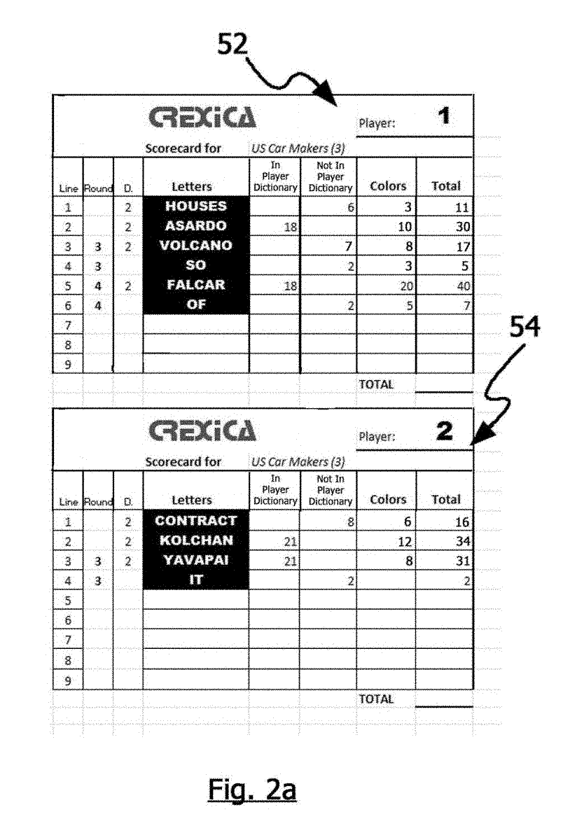

There may be only one scorekeeper for the game, however, for the preferred method of manual scoring, every player keeps score of the player sitting on his/her left on scorecards (40) such as the one depicted in FIG. 2. For computer based games, a programming routine keeps the score of each player. For one embodiment, most of the game's programming routines are run on a server computer under the control of a main organization such as crexicausa.org and crexicainternational.org and such main server computer will provide a plurality of services (such as developing and maintaining a regulated topic specific dictionary database) as described in more detail below.

For the currently preferred embodiment, Players receive points in at least one of the following ways:
(Note: A “New” tile is a tile placed on the board during a turn whereas an “Old” tile is a tile that was placed on the board during a previous turn)

FIRST: Every new tile played is worth at least 1 point. The new tiles of each word formed or modified during a turn are scored. The new word(s) formed is/are written in the column titled “Letters” (43) (see FIG. 2 and FIG. 2a).

When two or more words are formed in the same play, each word is scored. The common letter is counted although no premium/bonus points are awarded for “old tiles” as premium/bonus points are only given once and to the player who places a “new tile” on the premium/bonus square. For one alternative embodiment, bonus points are given each time a tile is used whether it is “old” or “new”.

As noted below, the subject multiplier is to be applied to all new words which can be found in the player's topic specific dictionary. Similarly, the bonus points based on special squares (colored squares for this embodiment) are applied to every new word.
(a) Word NOT in Topic Specific Dictionary: If a Player makes a word that is not in his/her player dictionary (i.e. the topic specific dictionary) but the word formed is a word, then no points are noted under “IN PLAYER DICT.” (44) but such player receives the tile count under “NOT IN PLAYER DICT.” (46).
   (Note: For the currently preferred embodiment, there should never be points under both the “IN PLAYER DICT.” column and the “NOT IN PLAYER DICT.” column)
(b) Word IN Topic Specific Dictionary: If a Player makes a word that is in his topic specific dictionary, the number of tiles used to form such word is multiplied by the dictionary multiplier and such value is placed in the column titled “IN PLAYER DICTIONARY” (44).
   (Note: each topic dictionary should list a dictionary multiplier, preferably on the front page of such dictionary) For example, for a 5 letter word in a topic specific dictionary with a multiplier of 3, the player should receive 15 points (3×5) in the “IN PLAYER DICT.” (44) column of the Scorecard (40). No entry is made under the column titled “NOT IN PLAYER DICT.” (46) Column.)
      Any adjoining and modified words are each scored and are scored in the same manner.
(c) Player Does not use Dictionary: If a Player uses his/her own knowledge and does not use a dictionary to look up a word during his/her turn, extra points are awarded under the “Dict. Used” column. For the currently preferred embodiment, once a player uses a dictionary, he/she cannot receive such bonus points for not using a dictionary again for the current game.

SECOND: If any tile is placed over a special square, (colored squares C1, C2, or C3 are examples of “special squares” as described above and as indicated in the board figures), bonus points are awarded for that type square. Such bonus points are documented on scorecard (40) in the column titled “Colors” (48) for every letter placed on a special square. Bonus points applies to newly placed tiles only (i.e. such bonus points for a particular square are awarded only once and only to the first player to use the color square). For the currently preferred embodiment, the multipliers are:
C1: Yellow squares: 2 points;
C2: Orange squares: 3 points; and
C3: Green squares: 5 points.

For example: If a 6 letter word has 1 letter on orange and 1 on yellow, the scorekeeper would indicate “5” (2+3=5) to the ‘Colors’ (48) column of the Scorecard (40). Of course any suitable color multiplier may be used without departing from the scope and spirit of the inventions. Further, the special squares for game board (10) are identified in this exemplary embodiment using color but any suitable means of identifying special squares may be used.

THIRD: The total number of points for each word is calculated and the total point count is placed in the column titled “Total” (50).

FORTH: Special Bonus points: Any 9 letter word receives an extra 10 points. Words with 10 or more letters receive an extra 15 points. If a player, with a full set of tiles, uses all of his tiles in one play, such player gets an extra 25 points for a total of 40 (15+25) points.

### Sample Moves

Figures FIG. 1a through FIG. 1d depict sample moves which are scored on the sample score card depicted in FIG. 2a. For such examples the game has 2 players.

As shown in FIG. 1a, the first player makes his starting move by placing the tiles spelling “houses” on his starting-point squares. A shown in FIG. 2b, the player receives “2” points under the “D” column because the player did not use the dictionary to look up the word. The word “HOUSES” is written under the column “LETTERS” and “6” points is documented under the “NOT IN PLAYER DICTIONARY” column as the word formed was not in the player's topic specific dictionary but is a word containing six letters. Further, the tile for the letter “S” is on a “C2” color square for a bonus of five (3) points. The total points are 13 (2+6+3=11). (NOTE: The letter “O” is on a “C1” color square, it is on a starting square).

As shown in FIG. 1b, the second player makes his starting move by placing the tiles spelling “CONTRACT” on his starting-point squares. A shown in FIG. 2b, the player receives “2” points under the “D” column because the player did not use the dictionary to look up the word. The word “contract” is written under the column “LETTERS” and “8” points is documented under the “NOT IN PLAYER DICTIONARY” column as the word formed was not in the player's topic specific dictionary but is a word containing eight letters. Further, the tile for the letter “A” and letter “T” are on a “C2” color square for a bonus of six (3+3) points. The total points, 16 (2+8+6), is documented in the “Total” column.

As shown in FIG. 1c, the first player makes his round 2 move by placing tiles on the board to form the word “ASARDO” using the old tile “O” from the previously formed word “HOUSE”. The player receives “2” points under the “D” column because the player did not use the dictionary to look up the word. The word “ASARDO” is written under the column “LETTERS” and “18” (6×3=18) points is documented under the “IN PLAYER DICTIONARY” column as the word formed was in the player's topic specific dictionary and the multiplier value is three. Further, five of the 6 tiles are new tiles and placed on a special square (color C1) for a bonus of ten (5×2) points. The total points are 30 (2+18+10=30).

As shown in FIG. 1d, the second player makes his round 2 move by placing tiles on the board to form the word “KOLCHAN” using the old tile “O” from the previously formed word “CONTRACT”. The player receives “2” points under the “D” column because the player did not use the dictionary to look up the word. The word “CONTRACT” is written under the column “LETTERS” and “21” (7×3=18) points is documented under the “IN PLAYER DICTIONARY” column as the word formed is in the player's topic specific dictionary and the multiplier value is three. Further, six of the seven tiles are new tiles and placed on a special square (color C1) for a bonus of ten (5×12) points. The total points are 30 (2+18+10=30).

FIG. 1e shows the remainder of the example moves. Further, FIG. 1e present the look/ornamental features where the squares labels “C1”, “C2”, and “C3” are replaced by shading.

In round 3, Player 1 forms the words “VOLCANO” and “SO” using the old tile “O” from “ASARDO”. Since neither word is in the Player 1 specific dictionary, the letter count for each word is document under “NOT IN PLAYER DICTIONARY” column. Notably, a player can only be awarded bonus points for not using the dictionary once per round/turn, thus, only “VOLCANO” receives such bonus points. The color bonus points are calculated as before but note that the tile “O” gets bonus points twice; once for each word formed.

Similarly, in Round 3, Player 2 forms the words “YAVAPI” and “IT” using the old tile “T” from “CONTRACT” and old tile “V” from “VOLCANO”.

Finally, in Round 4, Player 1 forms the words “FALCAR” and “OF” using the old tile “O” in “VOLCANO” and old tile “A” in “YAVAPI”. The game would continue until a game ending event occurs.

### Central Gaming Center

As previously noted, a computing device based game provides for many additional features over the board based game traditionally played by players sitting around a table. One feature provided by computing device based gaming system is the establishment of a main organization that will provide a plurality of services to people at locations anywhere there is a computer with access to a WAN. One embodiment of such main organization is a website on the Internet. Some of the functions of such website include: developing a member database, developing a regulated topic specific dictionary database and user defined dictionary data base, developing and maintaining the gaming software, developing a ranking system and ranking players who play rated games, developing a player ranking database, allowing for user defined groups (for example, members of a club or school class), providing an interface for members to log on and start games, arrange and monitor online championships competitions.

### Handheld Devices

For one embodiment, a handheld application specific computing device (or an application deployed on similar devices) is used to perform the gaming functions. Such handheld computing device comprises wired or wireless communication circuits (USB, an electronic communication channel, transmitters, etc.) for establishing a communication connection with a remote computer and may initiate the downloading of existing dictionaries or initiate the creation of new dictionaries.

One particular benefit of such devices, besides having game function specific function keys (in order to perform actions through some key sequences), is that such devices support the use of enhanced keyboards for the benefit of using extended alphabets, generating up to 15 extra keys for letters besides the standard 26 letters of the Latin alphabet. Additionally, such handheld computing devices will be configured to store a certain number of dictionaries and player related information.

### Electronic Access Routine

Exemplary processes for implementing electronic based games will now be considered. It should be appreciated that the order of many steps is somewhat arbitrary and the order presented in the exemplary flowcharts represents but one possible order selection. Further, not all steps presented in the following flowcharts may be necessary for performing the fundamental functions of the game.

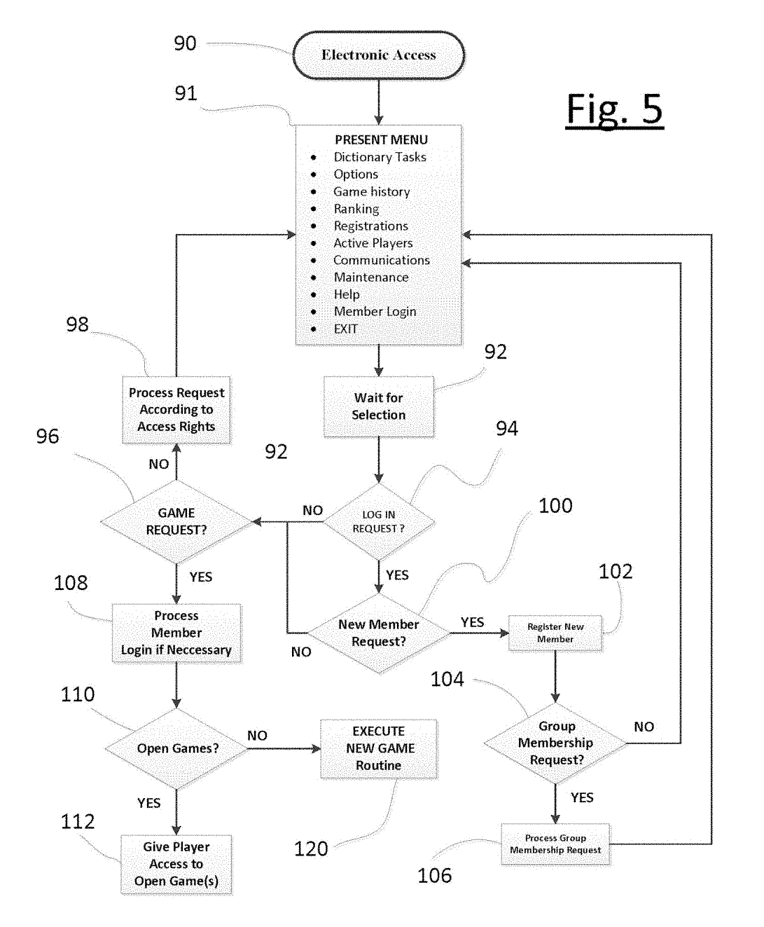

Referring now to FIG. 5 an ELECTRONIC ACCESS (90) routine is initially accessed. For Internet-based games, electronic access (90) routine may be the default page/home screen for a gaming website. The electronic access (90) routine presents a menu (91) presenting possible selections a player may choose. Exemplary selections include: Dictionary Tasks, Options, Game History, Ranking, Registrations, Active Players, Communications, Maintenance, Help, Member Login, and EXIT. Dictionary Tasks, for example, would allow a user to view and print, edit, and create new dictionaries. At step (92), the electronic device executing the electronic access (90) routine waits for a user selection. When a user makes a selection, the routine determines if such selection is a login request (94). If such selection is a login request, the electronic device checks to see if such request is a new member request (100). If such request is a new member request (100), then the routine registers the new member (102). The routine next prompts the user to indicate whether or not such user wishes to belong to a group. If the user wishes to belong to a group, the routine processes the group membership request (106). If the user does not wish to belong to a group, program control is passed back to menu (91).

Notably, there is no limit to the number and type of user groups that can be formed within the performance constraints of the hardware of the electronic systems hosting gaming software. For example, members of one group may belong to a particular high school, a debating club within the geographical area, a college, a country, or a single class being taught by a teacher at an educational facility. Such would allow a science teacher to start a group, give her students access to the group, where the teacher creates her own topic specific dictionaries for subjects being taught in her class, and wherein the students can login to the group and play each other to learn and develop a knowledge base of the material being taught. Such a system further allows such teacher to issue tests allowing her to quantify, rank, and compare the improvement of knowledge development among students within a class, a school, or over a geographical area.

If at step (94) the routine determines that the selection is not a login request, program control is passed to step (96). Similarly, if at step (96) the routine determines that a new game has been requested, the routine processes the login request (108), and if successful, passes control to step (110). If a login request is not successful, the routine executes an unsuccessful login attempt algorithm such as those commonly used by websites on the Internet.

At step (96) the routine determines if the user selection was not a “play game” request the user is allowed to login and the user request is processed according to the user's current access rights.

As noted above, if the user selection was a “play game” request, the user login is verified at step (108) and the routine checks to determine if the user requesting the game has any open games (110) pending. For example, a user could have been playing a game and lost Internet access. Further, some games my have no player move time limitations and the game may span a long period of time such as days, weeks, months, and years. Instead of automatically ending such games, the routine gives such user a certain amount time, including an unlimited amount of time, to log back onto the system and request access to the pending open game(s) (112). Further, the routine may send players an electronic notification (e-mail, text message, personal message over a social networking site, etc.) notifying the players a move has been made and perhaps further informing the players who has the next move. If there are no open games at step (110), program control is passed to an EXECUTE NEW GAME routine (120).

### Execute New Game

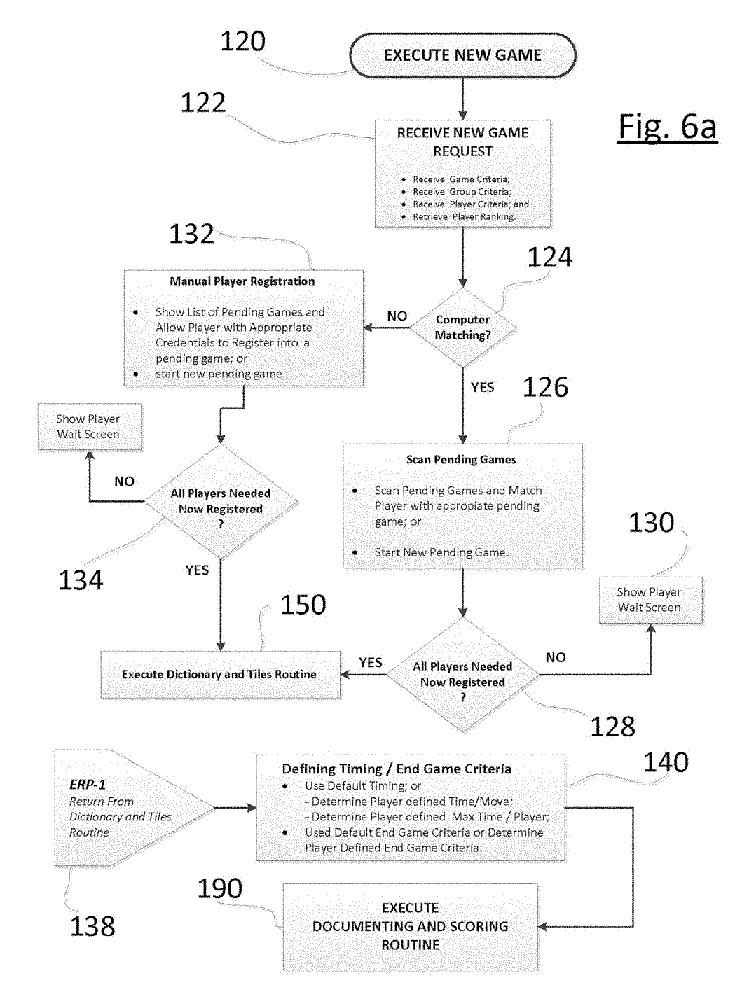

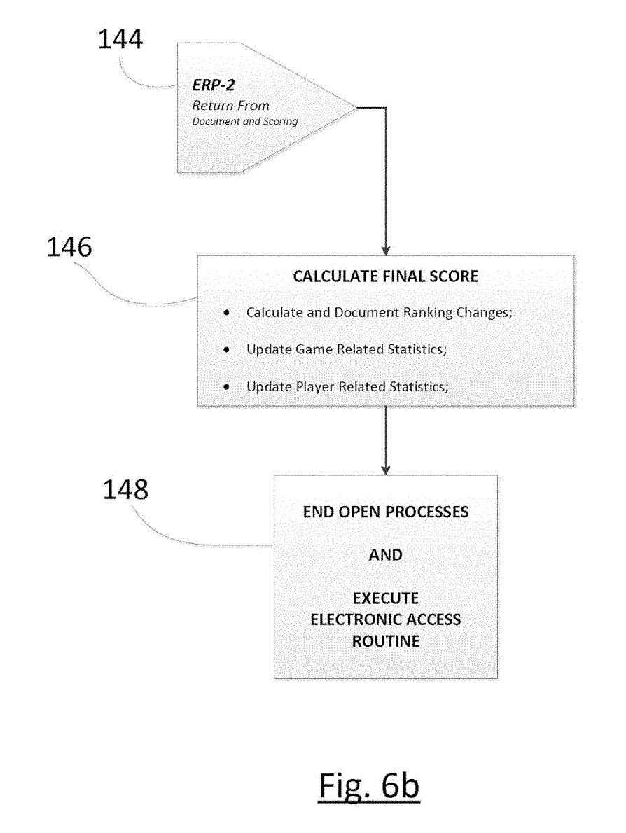

FIG. 6a and FIG. 6b present the exemplary EXECUTE NEW GAME (120) routine. The first step (122) is to determine the criteria needed to establish a new game including the parameters such as Game Criteria, Group Criteria, Player Criteria, and Player Ranking for user requesting the game. For example, game criteria would indicate whether or not the game will be an officially ranked game and group criteria would indicate if players allowed to play the game are restricted to a particular group. Player criteria would indicate the requesting player's requirements for other players to be allowed to join the game.

Next, program control is passed to step (124) where the routine determines (126) that the requesting player wishes to have the routine automatically set up a new game. If so, at step (126), the routine scans pending games to determine if any meet the required criteria. If so, the requesting player is given access to such pending game and the computer determines (128) if all players needed to start a game have been found. If not, the routine presents a wait screen (130) for the requesting player. If so, program control is passed to EXECUTE DICTIONARY, BOARDS, AND TILES ROUTINE (150).

If at step (124) the requesting player wishes to manually join or start a new game, program control is passed to step (132) where the player is presented with a list of pending games. If the requesting player wishes to join a pending game of which he has the appropriate credentials, the requesting player is given access to such pending game and program control passes to step (134). Otherwise the requesting player can start a new game governed by the established criteria identified above and program control passes to step (134). At step (134) the routine determines if all players for a pending game have been found. If not, the requesting player is presented with a wait screen. If all players needed to start the game have been found, program control is passed to the EXECUTE DICTIONARY, BOARD, AND TILES ROUTINE (150).

When program control returns from the execute dictionary and tiles retain (180) to ERP-1 (External Reference Point—one) at (138), the next step is to define the game timing and end of game criteria. Here the players decide the timing requirements, if any, for the game. For example, each player may be allotted a set amount time for each play such as 90 seconds. For such example, each player may have 90 seconds to make a move and a 90 second countdown timer would be used for each move.

Alternatively, each player may be given 30 minutes total for the entire game and the amount of time for each move is continuously deducted from such total using of a countdown timer until some players countdown timer reaches zero which ends the game.

The “end of game” criterion simply determines the events that, if they occur, end the game. For example, when all tiles in the game tile set have been used such can be at end of game event. Similarly, if a timer, such as a countdown timer, reaches a certain value, the game can end. Similarly, each player may be given a maximum amount of moves.

After defining the end of game criterion and the timing criterion, program control is passed to EXECUTE DOCUMENTING AND SCORING ROUTINE (190). When program control returns from the execute documenting and scoring routine (190) to ERP-2 (External Reference Point—one) at (144), a game ending event has occurred and program control passes to step (146) where in the game housekeeping task are performed such as verifying the final score, calculating any changes to the players ranking, verifying the final score, updating game statistics, updating any player related statistics, and any special task associated with a particular group. At step (148) open processes are closed/ended and program control is passed back to some other point such as menu screen (91).

### Dictionary, Board, and Tiles Routine

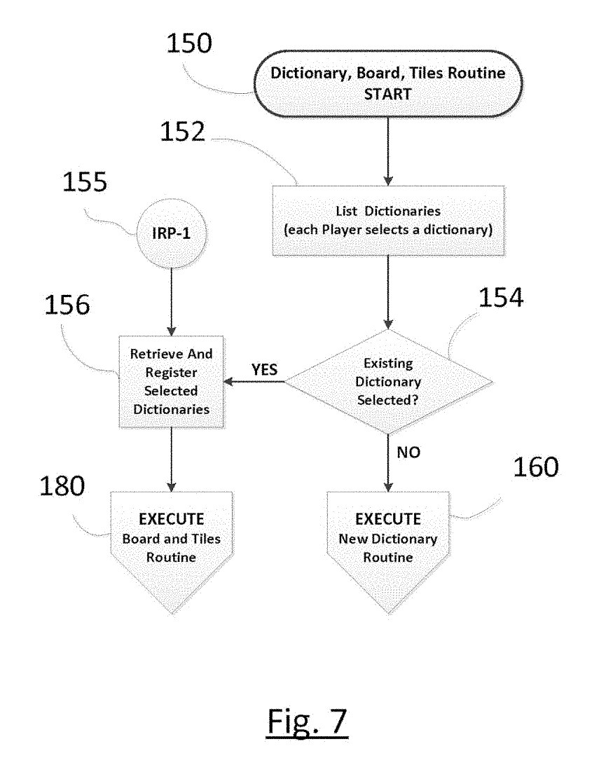

FIG. 7 present the exemplary DICTIONARY, BOARD, AND TILES ROUTINE (150) routine. Each player selects a topic specific dictionary at step (152). Such topic specific dictionary becomes the player dictionary for the player who selects such dictionary.

For one embodiment, the players are given the option to request a new topic specific dictionary. Such option will depend on the estimated time required to generate such a dictionary. For dictionaries requiring a significant amount time to compile and assemble, players will be required to request those dictionaries to be generated before a game begins. Further, if the player needs time to study the new topic specific dictionary (as some topic specific dictionaries may not include all possible words) he would likely be required to create and review the dictionary before the game. Such action, while allowable, is discouraged as one of the purposes of the apparatus is to make learning a topic specific dictionary fun.

At step (154), the routine determines if a player is going to select an existing dictionary or request a new dictionary be generated. If a player selects an existing dictionary, program control passes to step (156) where the selected dictionary is retrieved and registered for play and the BOARD IN TILES ROUTINE is executed.

### New Dictionary Routine

If at step (154) they play or request a new dictionary to be generated, the NEW DICTIONARY (160) routine is executed. If the routine determines that the new dictionary request cannot be executed within a predefined about of time (i.e. too much creation time needed, too much review time needed, etc.), the player is given the option to (a) exit the game and generate such dictionary, or (b) change at least one new dictionary criteria so that the NEW DICTIONARY routine can be executed within a predefined time limit, or (c) select a pre-existing dictionary. For the preferred embodiment, such time is one minute.

For the preferred embodiment, dictionary criteria define a precise set of attributes that increasingly narrows the scope of the dictionary. Such criterion includes Geographical Selection, Chronological Selection, Main Category, and Subcategory. Such selections are made at step (162).

Example options for the Geographical Selection include: the Universe; a Celestial Body; the Earth; a Continent(s); a Country(ies); a State(s); a City(ies); a County(ies); and a Town(s).

Example options for the Chronological Selections include: All Time; a Century(ies); a Decade(s); a Year(s); a Month(s); a Week(s); a particular date throughout a period of time (e.g. May 7); and Days.

Example options for the Main category selection include: Geography; History; Politics; Economy; Arts; Science; Sports; Society; Education; Armed Forces and famous battles; and Entertainment.

Example options for the subcategory selections include: Literature; Music; Painting; Sculpting; Performing Arts; and Free Form Arts.

After the above selections are identified at step (160) and the appropriate codes identifying such choices are generated, and at step (164), dictionary data is determined or collected from a user to help categorize and identified the new dictionary. For example, the player may be given the option to provide a dictionary identifier such as a name. Preferably the routine will provide the dictionary scheme identifier and topic identifier. Additionally, the user specifies the language to be used to form a dictionary. Next at step (166), the user is requested to provide the desired size, in number of words, for the new dictionary. Exemplary choices include: 1000; 2000; 5000; and more than 5000 words.

At step (168), the routine determines that the dictionary will be uploaded by the user or auto generated by a computer algorithm. If the user is going to upload a user-defined dictionary, program control passes to step (172) or internal reference point three (IRP-3). Otherwise, program control is passed to step (170) with is an auto generate routine starting at internal reference point two (IRP-2).

At step (174), an auto generate dictionary routine is performed. In such routine and algorithm is executed that searches at least one database using the dictionary criterion defined above. The database can reside on a local electronic device, a remote electronic device accessed through a network such as the Internet, webpages and information the words found on a network such as the Internet, or all of the above. The results returned are typically sorted, evaluated, and selected to provide the dictionary type and size (i.e. number of words) previously requested and defined by the user. To obtain the desired number of words (e.g. the search returned 15,000 words but dictionary is to contain only 10,000 words), the word selection process could be random, but preferably the word selecting process will provide a spectrum of words with starting characters across the full spectrum of the language used to form the dictionary. Character frequency and word frequency may be yet another criteria used for selecting words. For the preferred embodiment, however, the newly created topic specific dictionary contains all the words found to be eligible for such topic specific dictionary so that a player does not need to know what words are in, or not in, such dictionary.

If the user is going to upload a user-defined dictionary, program control is passed to step (173). At this step the user either uploads a user file or the user is allowed to manually input dictionary terms. The algorithm optionally verifies that the uploaded dictionary or manually enter dictionary is accurately identified by the above dictionary criterion, and if not, prompts the user to consider making a correction (or automatically makes the correction). Program controlled then passes to step (176) and performs the steps described above.

If more than one language is used to form the player dictionaries, after all the dictionaries are defined, the dictionary routine optionally generates character-equivalence-data comprising a list of equivalent letters across the different languages. For example German to English equivalents may include: “ä” and “a”; “ö” and “o”; and “ü” and “u”. For one alternative embodiment, one tile will show both characters defined to be equivalent such as “ö o”.

After a new dictionary is defined, at step (176) the algorithm defines or determines the dictionary multiplier, the total character count, and the letter frequency count for each unique letter found in the new dictionary. Next at step (178), the dictionary is designated as either regulated or unregulated and program control is returned to IRP-1 (155).

Once all dictionaries are defined and retrieved and register for play, the program executes the BOARD AND TILES ROUTINE (180). The board and tiles routine first checks, at step (182), to see if the default board and tile criterion should be used to generate the game board and game tile sets. If so, program control is passed to step (184) where the game board and game tile sets are generated based on the defined dictionaries and the default criterion. If not, at step (182), the players define the board size to be used, the Board shape to be used, bonus squares data (the configuration and number of bonus squares), symmetry data (e.g. should the Board be symmetric), tiles per player in the game tile set, and tile exceptions if any. Next program control is passed to step (184) were the game board and game tile sets are generated.

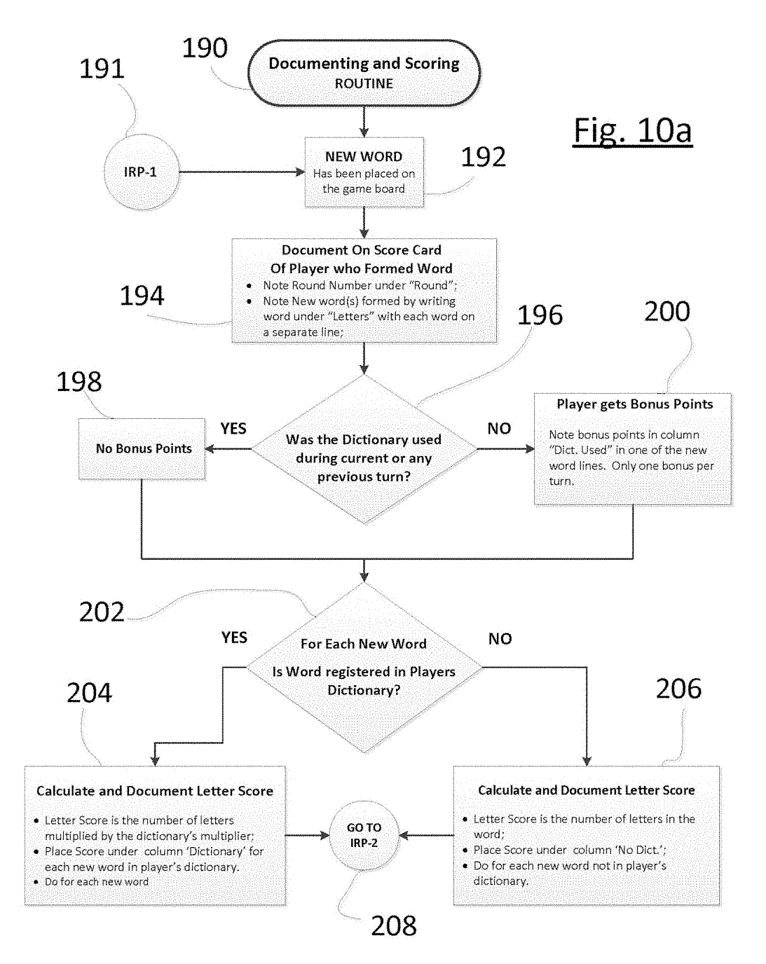

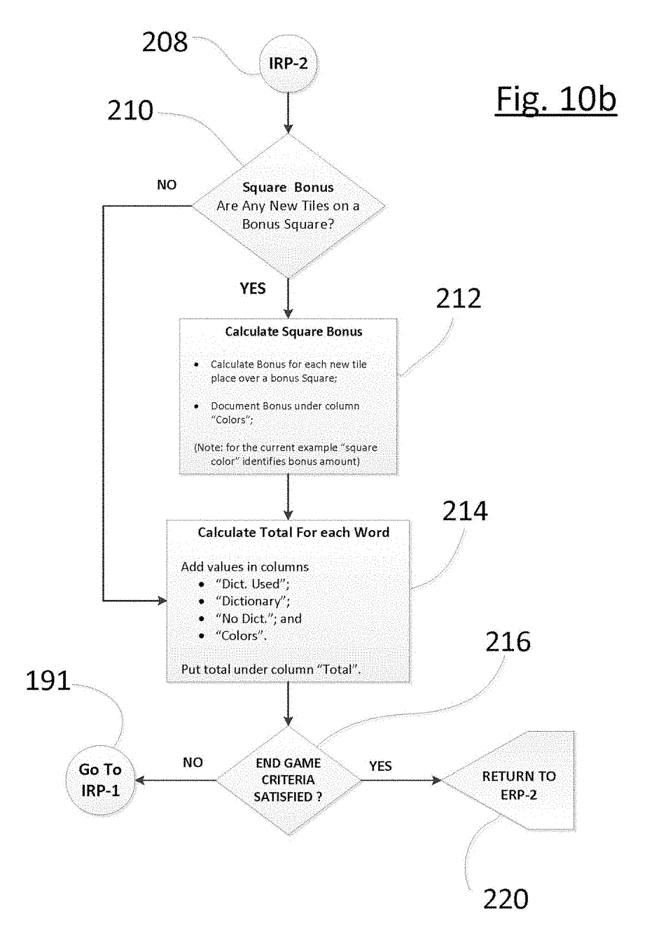

Once the player dictionaries are established in registered, the game board and game tile sets are generated, the game is ready to begin and program control is passed back to NEW GAME ROUTINE (FIG. 6a) where the DOCUMENTING AND STORING (190) routine is executed (FIG. 10).

### Documenting and Scoring Routine

Referring now to FIG. 10a and FIG. 10b, a DOCUMENTING AND SCORING (190) routine is presented. At step (192), a player has formed a new word or words on the game board before a turn in any event has occurred (e.g. before the user passes or if time runs out for that care or for the game). If the player cannot form a new word he forfeits his turn and no points are awarded and program control passes back to step (192) where the program waits for the next player to form a new word.

At step (194), a new word has been formed and the program documents the turn number and the new word or words formed on the electronic scorecard. At step (196), the scoring routine determines if a player has used the dictionary during the current or any previous turns (assuming bonus points are awarded for not using a dictionary). If the dictionary was used during the current turn or any previous turns, program control passes to step (198) and no bonus points are awarded and program control passes to step (202). If at step (196) the routine determines that a dictionary was not used during the current turn or any previous turn, program control is passed to step (200) where the bonus points are awarded and documented on the electronic scorecard and program control passes to step (202).

At step (202), the program calculates the point totals for each word formed during the current turn. If the word formed is in the player's dictionary, the letter score is calculated for each character forming the new word and bonus points are awarded. If the word formed is not in the player's dictionary, but is in the common dictionary for all players, the letter score is calculated for each character forming the new word and no bonus points are awarded. A brief delay may be provided at this point to allow other players to challenge the word or words formed. If challenged, the program automatically searches the appropriate dictionaries for the challenged word or words and makes a determination as to which player is correct. If the player forming a word is correct, the challenging player loses his next turn. If the challenging player is correct, the new words formed are removed from the board and the player forming the word loses the current turn and the next turn. Notably, if a player believes a dictionary is in error and a word is not in the dictionary that should be, for one embodiment the dictionary may be edited by adding the new word. Such addition may be contingent upon approval from a later executed word verification process.

Notably, for one alternative embodiment, if a group of tiles forms a word in both the forward and reverse direction, each such word is scored. For example, if, reading from left to right, a player forms the word “DOG”, which also spells the word “GOD” when read from right to left, both such words are scored.

Next at step (208), program control is passed to step (210) to determine if any special square bonus should be awarded. If none of the new tiles forming the new words are placed on special squares, no bonus points are awarded and program control passes to step (214). If however, one or more tiles are placed on a special square, program control passes to step (212) where special square bonus points are determined and awarded and documented on the electronic scorecard and program control passes to step (214). At step (214), the program calculates the total score for that turn for the player forming the words and the total is documented on the electronic scorecard and program control passes to step (216). At step (216), the program checks to see if an end of game event has occurred, and if so, program control passes to ERP-2 (220) of the EXECUTE NEW GAME routine. If at step (216) it is determined that an end of game event has not occurred, program control is passed back to IRP-1 at step (191) where the routine waits for the next player to form a word.

Eventually, a game ending event will occur and program control will be passed back to step (220) of the EXECUTED NEW GAME routine.

While the present subject matter has been described in detail with respect to specific embodiments thereof, it will be appreciated that those skilled in the art, upon attaining an understanding of the foregoing may readily adapt the present technology for alterations to, variations of, and equivalents to such embodiments. Accordingly, the scope of the present disclosure is by way of example rather than by way of limitation, and the subject disclosure does not preclude inclusion of such modifications, variations, and/or additions to the present subject matter as would be readily apparent to one of ordinary skill in the art.

What is claimed is:

1. An electronic based gaming system for providing an entertaining environment for enhancing a person's knowledge in a particular area, such system comprising:
a first computing device configured to communicate with a plurality of slave computing devices over at least one of a wide area network and a local area network;
wherein said first computing device is configured for generating display data and transmitting said display data to said plurality of slave computing devices, said display data comprising information necessary for each of said plurality of slave computing devices to generate at least part of a display image needed to play and document game status, said display data including board data defining a game board defining a playing area comprising a plurality of adjacent cells with each cell defining a cell-perimeter;
wherein said first computing device is configured to maintain a plurality of topic specific dictionaries comprising character images used to form words wherein each topic specific dictionary contains a collection of said words associated with its respective topic;
wherein said first computing device is further configured to maintain a list of players that are allowed access to the gaming system;
wherein said first computing device is further configured to associate at least one of said plurality of topic specific dictionaries to each player;
wherein said first computing device further maintains a set of game parameters including a set of rules for playing the game and a list of game ending events;
wherein said first computing device maintains a collective dictionary, comprising substantially all said words defined in the topic specific dictionaries associated with a player;
a game-tile-set generated by said first computing device and comprising a plurality of tiles wherein at least one outer surface of said game tile defines tile data wherein said tile data includes a character image needed to form at least part of a word defined in at least one of said topic specific dictionaries and said collective dictionary;
wherein said first computing device is configured to determine the frequency of the character images in said collective dictionary and generate said game-tile-set where the frequency of each character image in such game-tile-set is reflective of its respective frequency in said collective dictionary;
wherein said first computing device is further configured to randomly assign to each player a predefined number of tiles from said game-tile-set; and
wherein said first computing device is configured to electronically place game tiles on said game board in response to user input to form words according to said rules and document each player's accumulated points until a game ending event has been detected.

2. An electronic based gaming system as in claim 1, wherein said playing area defines a different starting point for each player.

3. An electronic based gaming system as in claim 2, wherein said playing area defines a grid of at least 25 by 25 squares and wherein each of said starting points define a set of five squares.

4. An electronic based gaming system as in claim 3, further comprising a standard dictionary and wherein said collective dictionary contains at least some of the words contained in such standard dictionary and wherein said first computing device determines character frequencies for each character in the collective dictionary and generates a game-tile-set of about 204 tiles wherein the frequency of each character image in said game-tile-set is reflective of its respective frequency in said collective dictionary.

5. An electronic based gaming system as in claim 4, wherein at least one topic specific dictionary is demographic specific, said demographic including at least one of age, gender, a range of intelligence quotient values, and skill level.

6. An electronic based gaming system as in claim 1, wherein said first computing device is configured to perform one of: (a) allow a player to define a new topic specific dictionary through either manual entry or file upload; and (b) allow a player to define a topic to be represented by a new topic specific dictionary and wherein said computing device is further configured to search at least one information source to find the collection of words forming the new topic specific dictionary.

7. An electronic based gaming system as in claim 6, wherein said information source is at least one of: (a) the Internet, (b) a database accessed through a wide area network; (c) a database accessed through a local area network, and (d) an electronic device associated with said first computing device.

8. An electronic based gaming system as in claim 1, wherein said first computing is configured to automatically retrieve location data from at least one of said plurality of slave computing devices and configure said display data in the official language for the location data.

9. An electronic based gaming system as in claim 8, wherein said location data is GPS data.

10. An electronic based gaming system as in claim 8, wherein said topic specific dictionaries is automatically generated using said location data.

11. A method for providing an electronic word based game, said method comprising the steps of:
configuring a first computing device to communicate with a plurality of slave computing devices over at least one of a wide area network and a local area network;
configuring said first computing device to further maintain a set of game parameters including a set of rules for playing the game and a list of game ending events;
configuring said first computing device to generate display data and transmit said display data to said plurality of slave computing devices, said display data comprising the information necessary for each of said plurality of slave computing devices to generate at least part of a display image needed to play said game and document game status, said display data defining a playing area comprising a plurality of adjacent cells;
configuring said first computing device to maintain a plurality of topic specific dictionaries comprising words composed of a sequence of character images wherein said words are associated with its respective topic;
configuring said first computing device to associate at least one of said plurality of topic specific dictionaries to each player playing said game;
configuring said first computing device to maintain a collective dictionary comprising words defined in the topic specific dictionaries associated with a player;
configuring said first computing device to generate a game-tile-set comprising a plurality of tiles wherein at least one outer surface of said game tile defines one of (a) a blank and (b) tile data wherein said tile data includes a character image needed to form at least part of a word defined in at least one of said topic specific dictionaries and said collective dictionary;
configuring said first computing device to determine the frequency of the character images in said collective dictionary and generate said game-tile-set where the frequency of each character image in such game-tile-set is reflective of its respective frequency in said collective dictionary;
configuring said first computing device to randomly assign to each player a predefined number of tiles from said game-tile-set; and
configuring said first computing to electronically place game tiles on said game board in response to user input to form words according to said rules and document each player's accumulated points until a game ending event has been detected.

12. A method for providing an electronic word based gaming system as in claim 11, further comprising the step of defining a starting point for each player on said game board.

13. A method for providing an electronic word based game as in claim 12, further comprising the step of supplying a standard dictionary and wherein said collective dictionary contains words contained in such standard dictionary.

14. A method for providing an electronic word based game as in claim 11, further comprising the steps of configuring said first computing device to receive dictionary-parameters from a user and further configuring said first computing device to search at least one information source using said dictionary-parameters to find and select the collection of words forming a new topic specific dictionary.
